(19) United States
(12) Patent Application Publication
(10) Pub. No.: US 2011/0223806 A1
(43) Pub. Date: Sep. 15, 2011

(54) VEHICLE USED POWER CHARGE ASSEMBLY FOR ELECTRONIC DEVICES

(76) Inventor: Ci-Hong You, Taipei County (TW)

(21) Appl. No.: 12/722,552

(22) Filed: Mar. 12, 2010

(51) Int. Cl. H01R 13/66

(52) U.S. Cl. 439/620.22

(57) ABSTRACT

A vehicle used power charge assembly for electronic devices includes an USB slot for receiving a USB plug; a substrate installed with a charging circuit which is coupled to the USB slot; a power input device installed on the substrate and coupled to the charging circuit for supplying power to an external electronic device from the charging circuit; a conductive wire having one end connected to the USB slot and another end connected to the power input device; and a conductive stub wire having one end connected to the power input device and another two ends connected to a positive electrode and a negative electrode of a battery. The present assembly can be adhered to a vehicle. In the movement of the vehicle, an external electronic device can be connected to an USB slot of the present invention through a transmission line.

### FIELD OF THE INVENTION

The present invention relates to a charging device, and in particular to a vehicle used power charge assembly for electronic device.

### BACKGROUND OF THE INVENTION

USB connectors have become a standard for connections of electronic devices. However many portable electronic devices need power charge for supplying electric power. Thus, these devices charge power from USB connector by inserting the USB connector to a computer device. However the computer device is generally located in a fixed place, but these portable electronic devices need power supply outsides and thus this will induce inconvenience in use. It is often that the handset has no power outsides, while the user needs to call out.

Thus, there is an eager demand for a novel design which can improve the prior art defect so as to provide a novel usage to resolve the difficult in the prior art.

### SUMMARY OF THE INVENTION

Thus, the object of the present invention is to provide a vehicle used power charge assembly, wherein the present invention can be adhered to a vehicle. In the movement of the vehicle, an external electronic device can be connected to an USB slot of the present invention through a transmission line. The power is from the battery of the vehicle itself to the power input device so as to convert voltage and then to the external electronic device for power charging. Thus, in movement of the vehicle, the external electronic device 6 can be charged. In the present invention, the vehicle may be a motorcycle, an electromotive bicycles, a car, a ship, etc.

To achieve above object, the present invention provides a vehicle used power charge assembly for electronic devices, including: an USB slot for receiving a USB plug; a substrate installed with a charging circuit which is coupled to the USB slot; a power input device installed on the substrate and coupled to the charging circuit for supplying power to an external electronic device from the charging circuit; a conductive wire having one end connected to the USB slot and another end connected to the power input device; and a conductive stub wire having one end connected to the power input device and another two ends connected to a positive electrode and a negative electrode of a battery.

The power input device includes a voltage stabilizer for stabilizing a voltage of an input current and a transformer for converting a voltage of the battery to a voltage of the external electronic device. The external electronic device is selected from one of handsets, GPS devices, and PDAs or an electric heating device.

The vehicle used power charge assembly of the present invention further comprises: a cylindrical casing; the casing having a receiving space; and one end of the receiving space is opened from a top end of the casing so as to form an opening; and the receiving space serves to receive the substrate and the charging circuit.

The various objects and advantages of the present invention will be more readily understood from the following detailed description when read in conjunction with the appended drawing.

### BRIEF DESCRIPTION OF THE DRAWINGS

FIG. 1 is a schematic view showing the elements of the present invention.

FIG. 2(A) shows one application of the present invention.

FIG. 2(B) shows another application of the present invention.

FIG. 3 shows that the present invention can be installed with a casing and a cover.

FIG. 4 shows that the assembly view of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

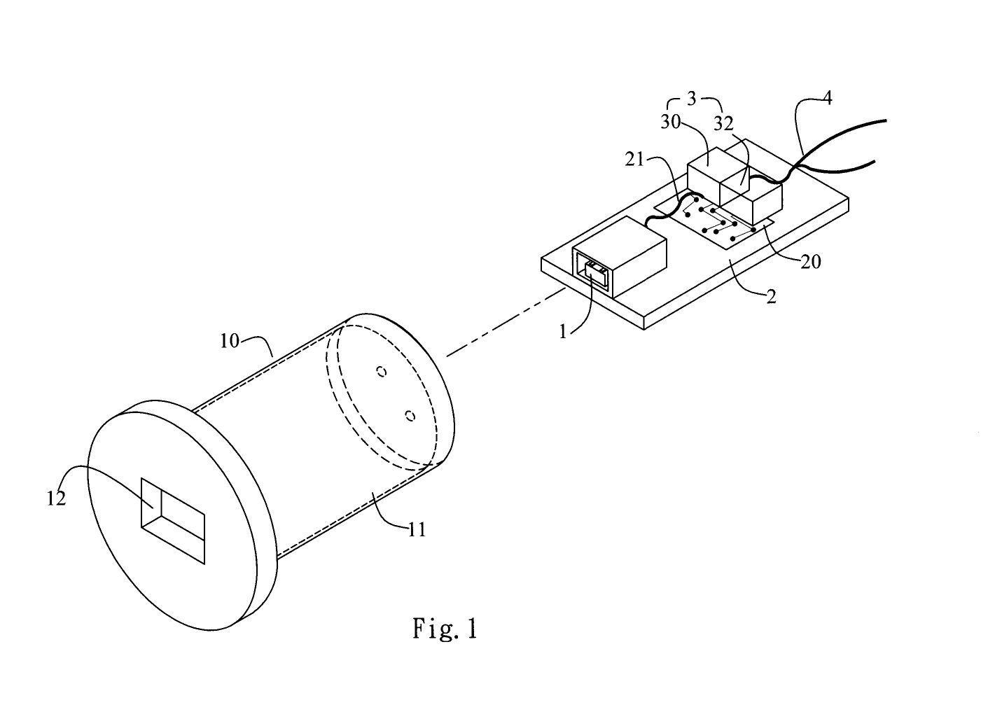

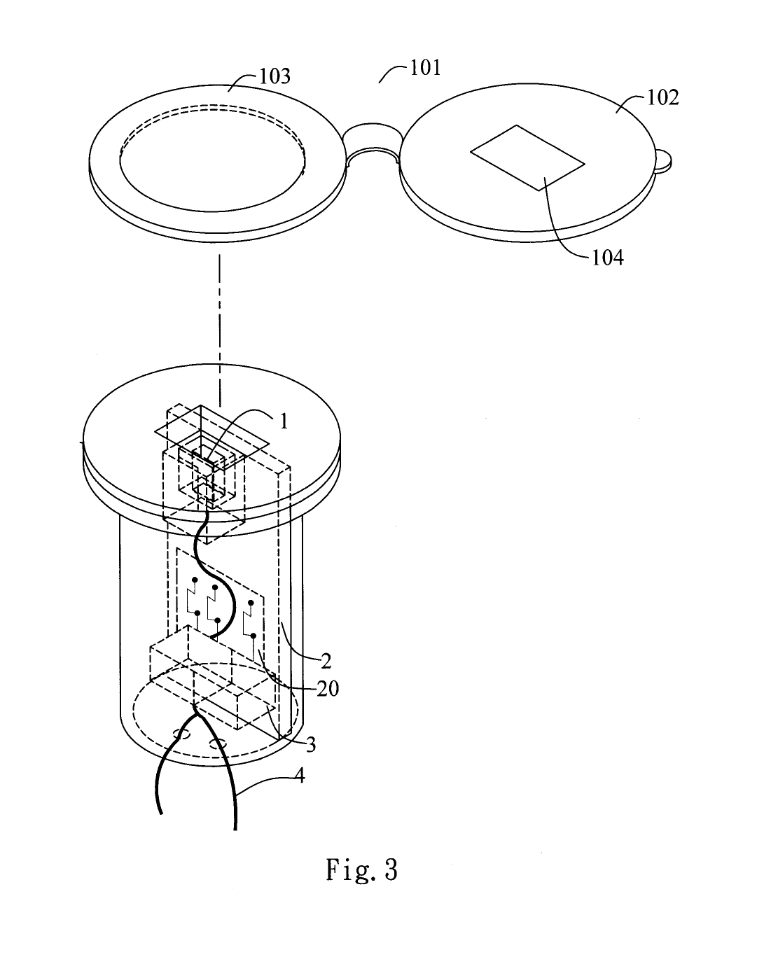

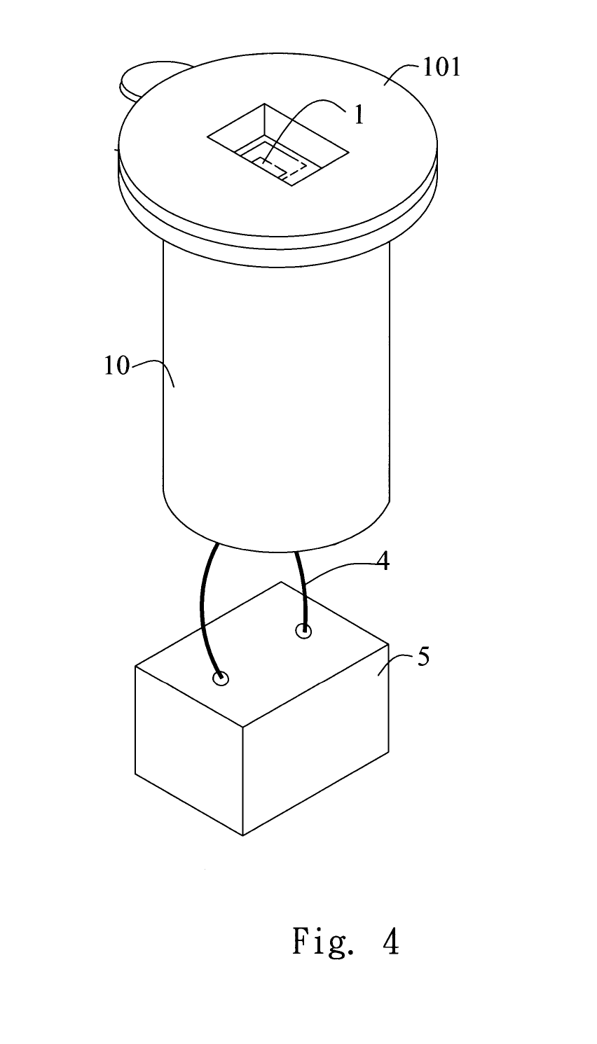

With referring to FIGS. 1 to 4, the power charging assembly used in a vehicle according to the present invention is illustrated. Referring to FIG. 1, the present invention includes the following elements.

An USB slot 1 severs for receiving a USB plug.

A substrate 2 is installed with a charging circuit 20 which is coupled to the USB slot 1.

A power input device 3 is installed on the substrate 2 and is coupled to the charging circuit 20 for supplying power to an external electronic device 6 from the charging circuit 20.

A conductive wire 4 has one end connected to the USB slot 1 and another end connected to the power input device 3.

A conductive stub wire 4 has one end connected to the power input device 3 and another two ends connected to a positive electrode and a negative electrode of a battery 5.

The power input device 3 includes a voltage stabilizer 5 for stabilizing a voltage of an input current and a transformer 32 for converting a voltage of 12 volt of the battery 5 to a voltage of 5 volt of an external electronic device 6.

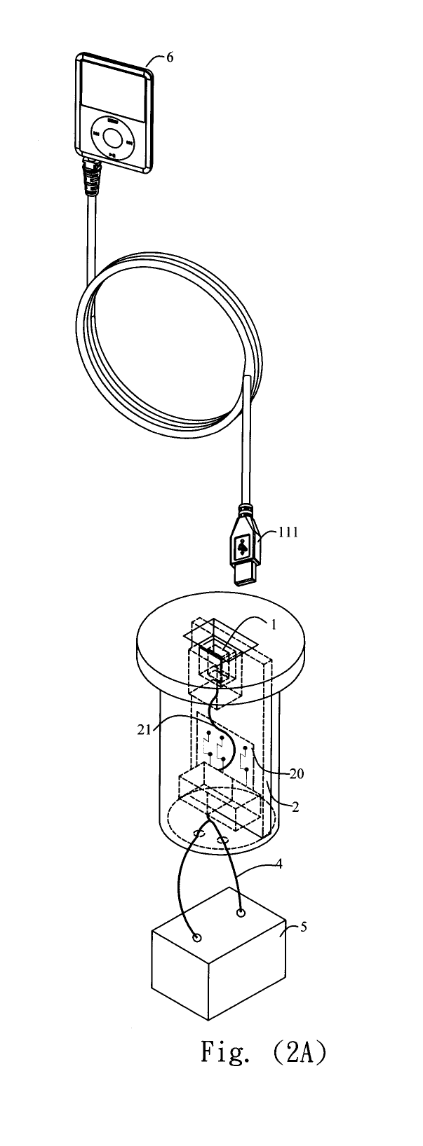

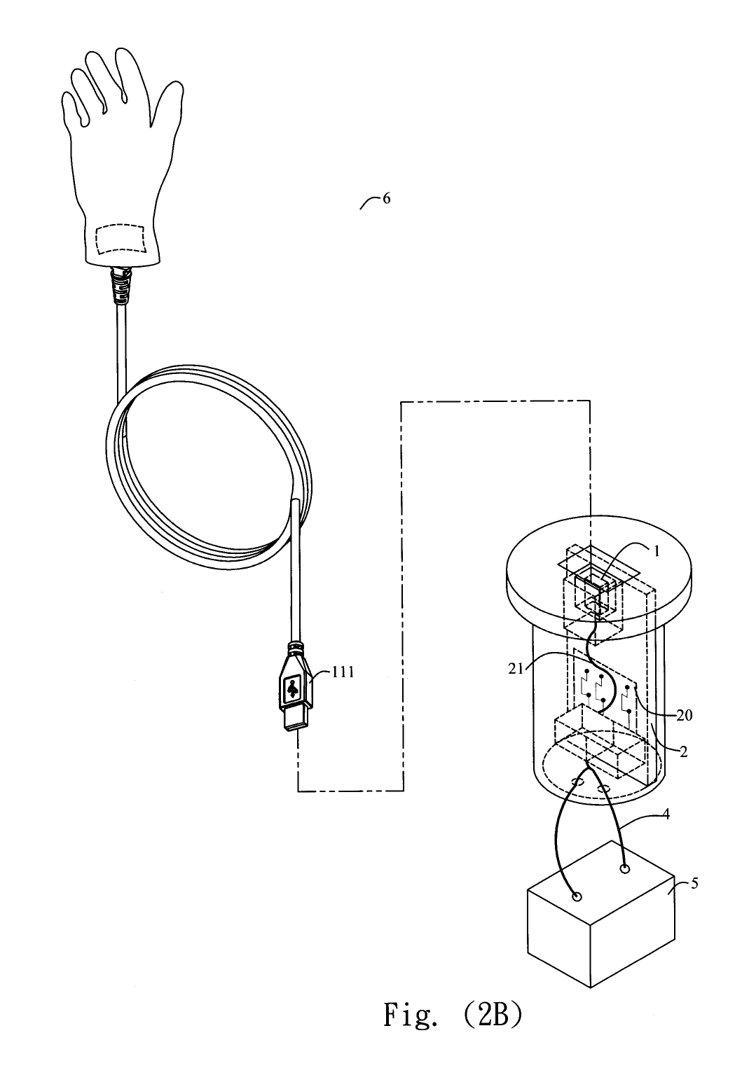

In the present invention, as illustrated in FIG. 1(A), the external electronic device 6 is selected from one of handsets, GPS devices, PDAs etc. Referring to FIGS. 2(B), in the present invention, the external electronic device 6 may be an electric heating device, such as an electric heating sheet installed with a glove for warming a hand within the glove.

Referring to FIGS. 1, 3, and 4, the present invention may further include a cylindrical casing 10. The casing 10 has a receiving space 11. One end of the receiving space 11 is opened from a top end of the casing 10 so as to form an opening 12. The receiving space 10 serves to receive the substrate 2 and the charging circuit 3.

A cover 101 serves for covering the opening 12 of the casing 10. The cover 101 includes a ring 102 adhering upon the top of the casing 10 and a covering sheet 103 covering the top of the casing 10. The covering sheet 103 has a hole 104 for exposing the USB slot 1.

In use, the present invention can be adhered to a vehicle. The battery 5 may be originally installed in the vehicle. In the movement of the vehicle, an external electronic device 6 can be connected to the USB slot 1 through a transmission line. The power is from the battery 5 of the vehicle itself to the power input device 3 so as to convert voltage from 12 volts to 5 volts and then to the external electronic device 6 for power charging. Thus, in movement of the vehicle, the external electronic device 6 can be charged. In the present invention, the vehicle may be a motorcycle, an electromotive bicycles, a car, a ship, etc.

Moreover, all the circuits of the present invention and the connections thereof are waterproof. This is especially useful as the present invention is installed to a motorcycle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A vehicle used power charge assembly for electronic devices, including:
an USB slot for receiving a USB plug;
a substrate installed with a charging circuit which is coupled to the USB slot;
a power input device installed on the substrate and coupled to the charging circuit for supplying power to an external electronic device from the charging circuit;
a conductive wire having one end connected to the USB slot and another end connected to the power input device; and
a conductive stub wire having one end connected to the power input device and another two ends connected to a positive electrode and a negative electrode of a battery.

2. The vehicle used power charge assembly, wherein the power input device includes a voltage stabilizer for stabilizing a voltage of an input current and a transformer for converting a voltage of the battery to a voltage of the external electronic device.

3. The vehicle used power charge assembly as claimed in claim 1, wherein the external electronic device is selected from one of handsets, GPS devices, and PDAs.

4. The vehicle used power charge assembly as claimed in claim 1, wherein the external electronic device is an electric heating device.

5. The vehicle used power charge assembly as claimed in claim 1, wherein the external electronic device is an electric heating sheet installed within a glove for warming.

6. The vehicle used power charge assembly as claimed in claim 1, further comprising:
a cylindrical casing; the casing having a receiving space ; and one end of the receiving space is opened from a top end of the casing so as to form an opening; and the receiving space serves to receive the substrate and the charging circuit.

7. The vehicle used power charge assembly as claimed in claim 6, further comprising a cover for covering the opening of the casing; the cover including a ring adhering upon a top of the casing and a covering sheet covering the top of the casing; and the covering sheet has a hole for exposing the USB slot.

8. The vehicle used power charge assembly as claimed in claim 1, wherein the USB slot, the power input device, the conductive wire, and the conductive stub wire are waterproof.
